(19) United States
(12) Patent Application Publication
(10) Pub. No.: US 2025/0088257 A1
(43) Pub. Date: Mar. 13, 2025

(54) BEAM SELECTION FOR USER EQUIPMENT

(71) Applicant: Nokia Technologies Oy, Espoo (FI)

(72) Inventors: Sami-Jukka HAKOLA, Oulu (FI); Juha Pekka KARJALAINEN, Oulu (FI); Mihai ENESCU, Espoo (FI)

(21) Appl. No.: 18/727,632

(22) PCT Filed: Jan. 10, 2023
(86) PCT No.: PCT/EP2023/050368

§ 371 Date: Jul. 9, 2024

(30) Foreign Application Priority Data
Jan. 13, 2022 (FI) 20225028

(51) Int. Cl. H04B 7/06; H04L 5/00

(52) U.S. Cl. CPC H04B 7/06966; H04B 7/06968; H04L 5/005

(57) ABSTRACT

Embodiments of the present disclosure relate to devices, methods, apparatuses and computer readable storage media of uplink beam selection for multi-panel capable user equipment. The method comprises in accordance with a determination that a timer associated with a validity of an antenna capability of a first device and one or more usable resources selected by the first device based on the antenna capability has expired, determining that one or more default resources are to be used for a sounding reference signal transmission from the first device to a second device; and determining a transmit beam associated with the sounding reference signal transmission based on the one or more default resources.

### FIELD

Embodiments of the present disclosure generally relate to the field of telecommunication and in particular to devices, methods, apparatuses and computer readable storage media of Uplink (UL) beam selection for multi-panel capable User Equipment (UE).

### BACKGROUND

The 3rd Generation Partnership Project (3GPP) has discuss about the enhancement on multi-beam operation including identifying and specifying features to facilitate UL beam selection for UEs equipped with multiple panels, for instance considering UL coverage loss mitigation due to Maximum Permissive Exposure (MPE) and scheduling flexibility of downlink and uplink beam resources in the system, based on UL beam indication with the unified Transmission Coordination Indicator (TCI) framework for UL fast panel selection.

### SUMMARY

In general, example embodiments of the present disclosure provide a solution of UL beam selection for multi-panel capable UE.

In a first aspect, there is provided a first device. The first device comprises at least one processor; and at least one memory including computer program codes; the at least one memory and the computer program codes are configured to, with the at least one processor, cause the first device at least to in accordance with a determination that a timer associated with a validity of an antenna capability of the first device and one or more usable resources selected by the first device based on the antenna capability has expired, determine that one or more default resources are to be used for a Sounding Reference Signal (SRS) transmission from the first device to the second device; and determine a transmit beam associated with the SRS transmission based on the one or more default resources.

In a second aspect, there is provided a method. The method comprises in accordance with a determination that a timer associated with a validity of an antenna capability of a first device and one or more usable resources selected by the first device based on the antenna capability has expired, determining that one or more default resources are to be used for an SRS transmission from the first device to the second device; and determining a transmit beam associated with the SRS transmission based on the one or more default resources.

In a third aspect, there is provided an apparatus comprising means for in accordance with a determination that a timer associated with a validity of an antenna capability of a first device and one or more usable resources selected by the first device based on the antenna capability has expired, determining that one or more default resources are to be used for an SRS transmission from the first device to the second device; and means for determining a transmit beam associated with the SRS transmission based on the one or more default resources.

In a fourth aspect, there is provided a computer readable medium stored thereon for performing at least in accordance with a determination that a timer associated with a validity of an antenna capability of a first device and one or more usable resources selected by the first device based on the antenna capability has expired, determining that one or more default resources are to be used for an SRS transmission from the first device to the second device; and determining a transmit beam associated with the SRS transmission based on the one or more default resources.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of UL beam selection for multi-panel capable UE according to some example embodiments of the present disclosure;

FIG. 3 shows a flowchart of an example method of UL beam selection for multi-panel capable UE according to some example embodiments of the present disclosure;

FIG. 4 shows a simplified block diagram of a device that is suitable for implementing example embodiments of the present disclosure; and

FIG. 5 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements. These elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

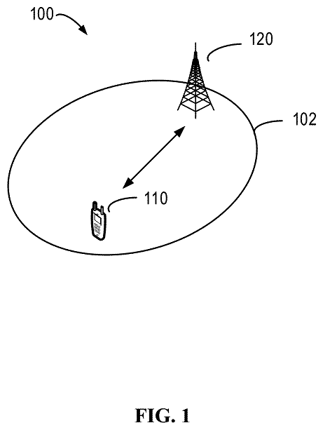

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). The network device 120 can manage a cell 102. The terminal device 110 and the network device 120 can communicate with each other in the coverage of the cell 102.

It is to be understood that the number of network devices and terminal devices shown in FIG. 1 is given for the purpose of illustration without suggesting any limitations. The communication network 100 may include any suitable number of network devices and terminal devices.

Beam Management defines a set of functionalities to assist UE to set its Receive (RX) and Transmit (TX) beams for downlink receptions and uplink transmissions, respectively. The functionalities can be categorized roughly according to four groups, namely beam Indication, beam acquisition, measurement and reporting, beam recovery and beam tracking and refinement.

Some beam management procedures are supported within one or multiple Transceiver Points (TRPs) of the serving cell. For example, UE measurement on different TRP Tx beams may be enabled to support selection of TRP Tx beams/UE Rx beam(s). UE measurement on different TRP Tx beams may be enabled to possibly change inter/intra-TRP Tx beam(s). UE measurement on the same TRP Tx beam may be enabled to change UE Rx beam in the case UE uses beamforming.

Regarding downlink beam indication, quasi-colocation (QCL) indication functionality has been defined. The principle to receive certain physical signal or physical channel is: the UE is either configured with or the UE implicitly determines a source/reference Reference Signal (RS) that UE has received and measured earlier which defines how to set RX beam for the reception of the downlink (target) physical signal or channel to be received. To provide UE with QCL characteristics for the target signal (to be received), a TCI framework has been defined, using which UE can be configured with TCI state(s) to provide UE with source RS(s) for determining QCL characteristics. Each TCI state includes one or two source RSs that provide UE QCL TypeA, TypeB, TypeC and/or TypeD parameters.

In uplink, the UE may be provided with a parameter called spatial relation information which may provide a spatial source RS. Based on spatial source RS, the UE may determine the UL Tx beam. The spatial source RS may refer to Downlink (DL) RS, such as Synchronization Signal Block (SSB) or Channel State Information Reference Signal (CSI-RS), or UL RS, such as SRS. For each Physical Uplink Control Channel (PUCCH) and SRS resource, the gNB may provide explicitly spatial source while for Physical Uplink Shared Channel (PUSCH) indirect indication is provided. In case the spatial source RS is a downlink RS the UE would use as transmit spatial filter the same spatial filter as it used to receive and measure the spatial source downlink RS. In case the spatial source RS is an uplink RS the UE would use as transmit spatial filter the same spatial filter as it used to transmit earlier the spatial source RS.

In release 17, the unified TCI framework has been introduced, which means that TCI states so far providing QCL assumptions for the reception of DL signals and channels would be used also to provide spatial sources for the transmission of UL signals and channels.

Furthermore, the unified TCI framework defines the concept of indicated TCI state. The indicated TCI state can be joint DL and UL TCI state or separate DL and separate UL TCI states. The indicated TCI state provides QCL source (DL) and spatial source (UL) for the set of downlink signals and channels and for the set of uplink signals and channels, respectively. In release 17, there can be one indicated joint DL and UL or one indicated DL and one indicate UL TCI state for the UE. The Unified TCI framework is expected to be extended in release 18 so that there can be then multiple indicated DL and UL TCI states.

For the unified TCI framework, some aspects have been agreed, for example, common TCI state (i.e., the indicated TCI) for a set of signals and channels at a time; TCI state can be joint DL/UL, separate DL TCI state and separate UL TCI state, Radio Resource Control (RRC) configures set (or pool) of joint and/or separate TCI states, Medium Access Control (MAC) activates a number (e.g. 8) of joint and/or separate TCI states and DCI indicates one of the activated TCI states to be indicated TCI state (which may be a common TCI state).

Furthermore, the DCI-based TCI state indication has also been agreed. DCI format 1_1/1_2 with and without DL assignment may be used to carry the TCI state indication.

The aim of the fast UL panel/beam selection topic is to facilitate fast beam/panel selection for the UL transmission of the UE which is having Tx and Rx panels with different capabilities. The UE may provide different capabilities among the panels comprising different number of antenna ports and different number of beams.

It has been agreed that UE-initiated panel activation and selection can be facilitated via UE reporting a list of UE capability value sets, the correspondence between each reported CSI-RS and/or SSB resource index and one of the UE capability value sets in the reported list is determined by the UE and is informed to network in a beam reporting instance.

The alignment, i.e., panel and corresponding panel capability between UE and gNB is based on the UE reporting. The reporting, for example, can be periodic, semi-persistent or aperiodic. The periodic reporting provides reliable and stable baseline operation but with the cost of system overhead and reduced scheduling flexibility for the gNB. Thus, in general semi-persistent and especially aperiodic reporting is tempting option from the network point of view. Assuming that the aperiodic reporting may also be supported for the enhanced SSB resource index (SSBRI)/CSI-RS resource index (CRI) reporting to carry capability value set index.

Since the capability of the UE may be changed after the UE reporting is transmitted. It is to be discussed that how to deal with the case where there is no any valid SSBRI/CRI and capability value set index combination or when there is a time interval passed since the last report (and/or measurement) that the alignment between gNB and UE cannot be assumed to hold.

The solution of the present disclosure proposes a mechanism of UL beam selection for multi-panel capable UE. In this solution, if the UE determines that a timer associated with a validity of an antenna capability of the UE and one or more usable resources selected by the first device based on the antenna capability has expired, the UE may determine that one or more default resources are to be used for a SRS transmission from the UE to the gNB. Then the UE may determine a transmit beam associated with the SRS transmission based on the one or more default resources.

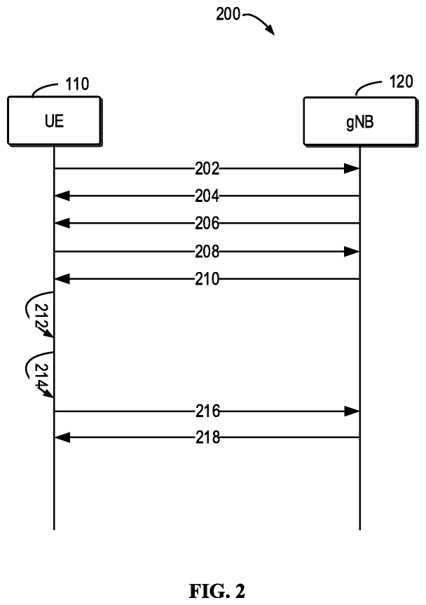

Principle and implementations of the present disclosure will be described in detail below with reference to FIG. 2, which shows a signaling chart illustrating a process 200 of UL beam selection for multi-panel capable UE according to some example embodiments of the present disclosure. For the purpose of discussion, the process 200 will be described with reference to FIG. 1. The process 200 may involve the UE 110 and the gNB 120.

Now the reference is made to FIG. 2. As shown, the UE 110 may transmit 202 one or more capability value sets to the gNB 120. For example, the UE 110 may provide gNB with three capability value sets, which may be represented as “capability value set index #0: number of SRS ports is 1”, “capability value set index #1: number of SRS ports is 2” and “capability value set index #2: number of SRS ports is 1”. The UE 110 may provide the capability value sets for instance in RRC connection setup.

After receiving the capability value sets, the gNB 120 may transmit 204 a configuration of the SRS resources or SRS resource sets to the UE 110. The configuration of the SRS resources or SRS resource sets may be determined by the gNB 120 based on the capability value sets provided by the UE 110.

For example, the configuration may be represented as “SRS resource or resource set #0 for codebook based PUSCH associated to capability value set index #0, i.e., each SRS resource is having 1 antenna port”, “SRS resource or resource set #1 for codebook based PUSCH associated to capability value set index #1, i.e., each SRS resource is having 2 antenna ports”, and “SRS resource or resource set #2 for codebook based PUSCH associated to capability value set index #2, i.e., each SRS resource is having 1 antenna port”.

The gNB 120 may transmit 206 configuration of the SSBRI/CRI with capability value set index reporting to the UE 110, which may indicate UE 110 to measure and report at least one best SSBRI/CRI. For example, the at least one best SSBRI/CRI may have a Reference Signal Received Power exceeding a threshold level. The number of the best SSBRI(s)/CRI(s) can be up to 4.

After receiving the configuration, the UE 110 may measure the SSB/CSI-RS resource pool and transmit 208 a report including the determined at least one SSBRI(s)/CRI(s) along with corresponding capability value set index to the gNB 120.

In some example embodiments, the report can be provided aperiodically, i.e. triggered once by the gNB, semi-periodically or periodically.

Then the gNB 120 may transmit 210 configuration and/or activation of the SRS resource or SRS resource set currently in use and corresponding spatial relation assumption to determine UL TX beam. For example, the spatial relation assumption can be spatial relation RS or QCL-TypeD RS of the TCI state.

The UE 110 may determine 212 whether a timer has expired. The timer may be associated with a validity of the antenna capability of the UE 110 and one or more usable resources selected by the first device based on the antenna capability, i.e., associated with a validity of the reported capability value set and the reported one or more SSB resources or CSI-RS resources. Hereinafter the terms “the antenna capability” may relate to a capability value set index currently used by the UE, which may refer to the number of antenna ports that UE supports for SRS resource.

If the timer has expired, the UE 110 may change the current SRS resource or SRS resource set assumption to one or more default resources. For example, the one or more default resources may correspond to the lowest capability of the UE 110, for example, in terms of number of SRS antenna ports.

It is to be understood that if the timer has expired, the gNB 120 may also change the current SRS resource or SRS resource set assumption to one or more default resources.

As an option, the time duration of the timer can be configured by the gNB 120. As another option, the time duration of the timer may also be determined by the UE 110 and the provided from the UE 110 to the gNB 120 in the capability signalling.

In some example embodiments, the UE 110 may start the timer when the UE 110 receives the configuration of the SSBRI/CRI with capability value set index reporting. It is also possible that the UE 110 may start the timer when the report is transmitted.

Then the UE 110 may determine 214 the transmit beam for the determined SRS resource or SRS resource set.

In some example embodiments, if the SRS resource or SRS resource sets are configured to follow the indicated TCI state (joint DL/UL or UL TCI state), the UE 110 may apply current indicated TCI state for the SRS resource or resource set to determine the transmit beam.

In some example embodiments, the UE may determine transmit beam for the SRS resource or resource set by spatial relation RS or QCL-TypeD RS of the TCI state provided for the PUCCH resource with lowest ID.

In some example embodiments, the UE may determine transmit beam for the SRS resource or resource set by spatial relation RS or QCL-TypeD RS of the TCI state provided for the last transmitted (any) SRS resource or resource set.

In some example embodiments, the UE may determine transmit beam for the SRS resource or resource set by spatial relation RS or QCL-TypeD RS of the TCI state provided for the last referred SRS resource or resource set in DCI by Sounding Reference Signal Resource Indication (SRI) field when PUSCH was scheduled.

It is also possible that the UE may determine transmit beam for the SRS resource or resource set by spatial relation RS or QCL-TypeD RS of the TCI state of the configured grant PUSCH if configured and active when the timer expires.

As shown, the UE 110 may be triggered the aperiodic reporting by the gNB 120. Then the UE 110 may measure the SSB/CSI-RS resource pool and transmit 216 a report including the determined at least one SSBRI(s)/CRI(s) along with corresponding capability value set index to the gNB 120. Similarly, the UE 110 may start the timer upon the reception of the configuration of the SSBRI/CRI with capability value set index reporting or the transmission of the reporting. The gNB 120 may transmit 218 configuration and/or activation of the SRS resource or SRS resource currently in use and corresponding spatial relation assumption.

In this way, a mechanism of UL beam selection in a case where the reported alignment does not hold any more can be achieved.

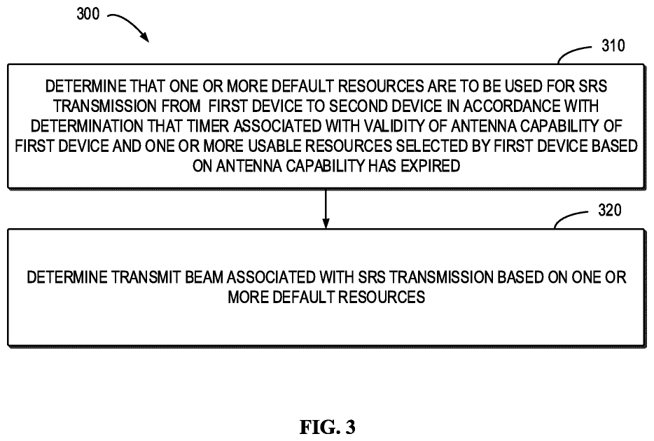

FIG. 3 shows a flowchart of an example method 300 of UL beam selection for multi-panel capable UE according to some example embodiments of the present disclosure. The method 300 can be implemented at the first device 110 as shown in FIG. 1. For the purpose of discussion, the method 300 will be described with reference to FIG. 1.

At 310, if the first device determines that a timer associated with a validity of an antenna capability of the first device and one or more usable resources selected by the first device based on the antenna capability has expired, the first device determines that one or more default resources are to be used for a SRS transmission from the first device to the second device.

At 320, the first device determines a transmit beam associated with the SRS transmission based on the one or more default resources.

In some example embodiments, the first device may transmit, to the second device, a report of the antenna capability of the first device and at least one reference resource measured by the first device based on the antenna capability of the first device.

In some example embodiments, the first device may transmit the report aperiodically, semi-periodically or periodically.

In some example embodiments, the first device may start the timer at a time point when configuration information is received from the second device, the configuration information being used for the first device to measure and report the antenna capability and the at least one reference resource.

In some example embodiments, the first device may start the timer at a time point when the first device transmits the report.

In some example embodiments, the first device may obtain a time duration associated with the timer from the second device.

In some example embodiments, the first device may determine a time duration associated with the timer; and provide, to the second device, the time duration along with a report of a set of antenna capabilities of the first device.

In some example embodiments, the first device may determine a subset of resources from the one or more current usable resources as the one or more default resources, the subset of resources being corresponding to a lowest antenna capability of the first device.

In some example embodiments, if the first device determines that the one or more default resource are configured based on the indicated TCI state, the first device may determine the transmit beam based on the indicated TCI state.

In some example embodiments, the first device may determine the transmit beam based on at least one of a spatial relation RS or a QCL TypeD RS of the TCI state provided for a resource associated with an uplink control channel having a lowest resource index; a spatial relation RS or a QCL TypeD RS of the TCI state provided for one or more resources that have been transmitted from the second device, a spatial relation RS or a QCL TypeD RS of the TCI state provided for one or more resources indicated in downlink control information, or a spatial relation RS or a QCL TypeD RS of the TCI state of a configured grant for the an uplink data channel.

In some example embodiments, the first device comprises a terminal device and the second device comprises a network device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for in accordance with a determination that a timer associated with a validity of an antenna capability of a first device and one or more usable resources selected by the first device based on the antenna capability has expired, determining that one or more default resources are to be used for a Sounding Reference Signal, SRS, transmission from the first device to the second device; and means for determining a transmit beam associated with the SRS transmission based on the one or more default resources.

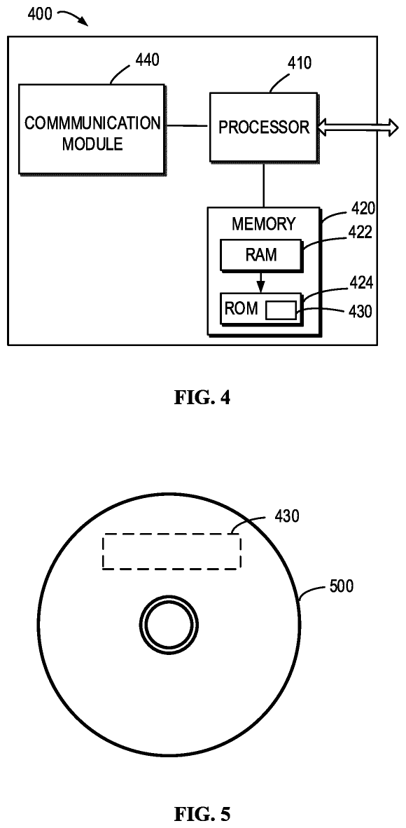

FIG. 4 is a simplified block diagram of a device 400 that is suitable for implementing embodiments of the present disclosure. The device 400 may be provided to implement the communication device, for example the UE 110 as shown in FIG. 1. As shown, the device 400 includes one or more processors 410, one or more memories 440 coupled to the processor 410, and communication modules 440 coupled to the processor 410.

The communication module 440 is for bidirectional communications. The communication module 440 has one or more communication interfaces to facilitate communication with one or more other modules or devices. The communication interfaces may represent any interface that is necessary for communication with other network elements. In some example embodiments, the communication module 440 may include at least one antenna.

The processor 410 may be of any type suitable to the local technical network and may include one or more of the following: general purpose computers, special purpose computers, microprocessors, digital reference signal processors (DSPs) and processors based on multicore processor architecture, as non-limiting examples. The device 400 may have multiple processors, such as an application specific integrated circuit chip that is slaved in time to a clock which synchronizes the main processor.

The memory 420 may include one or more non-volatile memories and one or more volatile memories. Examples of the non-volatile memories include, but are not limited to, a Read Only Memory (ROM) 424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 422 and other volatile memories that will not last in the power-down duration.

A computer program 430 includes computer executable instructions that are executed by the associated processor 410. The program 430 may be stored in the ROM 420. The processor 410 may perform any suitable actions and processing by loading the program 430 into the RAM 420.

The embodiments of the present disclosure may be implemented by means of the program 430 so that the device 400 may perform any process of the disclosure as discussed with reference to FIGS. 2 to 3. The embodiments of the present disclosure may also be implemented by hardware or by a combination of software and hardware.

In some embodiments, the program 430 may be tangibly contained in a computer readable medium which may be included in the device 400 (such as in the memory 420) or other storage devices that are accessible by the device 400. The device 400 may load the program 430 from the computer readable medium to the RAM 422 for execution. The computer readable medium may include any types of tangible non-volatile storage, such as ROM, EPROM, a flash memory, a hard disk, CD, DVD, and the like. FIG. 5 shows an example of the computer readable medium 500 in form of CD or DVD. The computer readable medium has the program 430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-15. (canceled)

16. A first device comprising:
at least one processor; and
at least one memory storing computer program codes that, when executed by the at least one processor, cause the first device at least to:
in response to determining that a timer associated with a validity of an antenna capability of the first device and one or more usable resources selected by the first device based on the antenna capability has expired,
determine that one or more default resources are to be used for a sounding reference signal (SRS) transmission from the first device to a second device; and
determine a transmit beam associated with the SRS transmission based on the one or more default resources.

17. The first device of claim 16, wherein the computer program codes, when executed by the at least one processor, further cause the first device at least to:
transmit, to the second device, a report of the antenna capability of the first device and at least one reference resource measured by the first device based on the antenna capability of the first device.

18. The first device of claim 17, wherein to transmit the report comprises:
transmit the report aperiodically, semi-periodically or periodically.

19. The first device of claim 17, wherein the computer program codes, when executed by the at least one processor, further cause the first device at least to:
start the timer upon receiving configuration information from the second device, the configuration information being used for the first device to measure and report the antenna capability and the at least one reference resource.

20. The first device of claim 17, wherein the computer program codes, when executed by the at least one processor, further cause the first device at least to:
start the timer at a time point when the first device transmits the report.

21. The first device of claim 17, wherein the computer program codes, when executed by the at least one processor, further cause the first device at least to:
start the timer at a time point when the at least one reference resource is measured by the first device based on the antenna capability of the first device.

22. The first device of claim 16, wherein the computer program codes, when executed by the at least one processor, further cause the first device at least to:
obtain a time duration associated with the timer from the second device.

23. The first device of claim 16, wherein the computer program codes, when executed by the at least one processor, further cause the first device at least to:
determine a time duration associated with the timer; and
provide, to the second device, the time duration along with a report of a set of antenna capabilities of the first device.

24. The first device of claim 16, wherein to determine that one or more default resources are to be used for the SRS transmission comprises:
determine a subset of resources from the one or more current usable resources as the one or more default resources, the subset of resources being corresponding to a lowest antenna capability of the first device.

25. The first device of claim 16, wherein to determine the transmit beam comprises:
in response to determining that the one or more default resource are configured based on an indicated Transmission Coordination Indicator, (TCI) state, determine the transmit beam based on the indicated TCI state.

26. The first device of claim 16, wherein to determine the transmit beam comprises:
to determine the transmit beam based on at least one of:
a spatial relation Reference Signal (RS) or a Quasi Co-location (QCL) TypeD RS of a TCI state provided for a resource associated with an uplink control channel having a lowest resource index,
a spatial relation RS or a QCL TypeD RS of a TCI state provided for one or more resources that have been transmitted from the second device,
a spatial relation RS or a QCL TypeD RS of a TCI state provided for one or more resources indicated in downlink control information, or
a spatial relation RS or a QCL TypeD RS of a TCI state of a configured grant for an uplink data channel.

27. The first device of claim 16, wherein the first device comprises a terminal device and the second device comprises a network device.

28. A method comprising:
in response to determining at a first device that a timer associated with a validity of an antenna capability of the first device and one or more usable resources selected by the first device based on the antenna capability has expired, determining at the first device that one or more default resources are to be used for a sounding reference signal (SRS) transmission from the first device to a second device; and
determining at the first device a transmit beam associated with the SRS transmission based on the one or more default resources.

29. The method of claim 28, further comprising:
transmitting, from the first device to the second device, a report of the antenna capability of the first device and at least one reference resource measured by the first device based on the antenna capability of the first device.

30. The method of claim 29, further comprising:
starting, at the first device, the timer at a time point upon receiving configuration information from the second device, the configuration information being used for the first device to measure and report the antenna capability and the at least one reference resource; or
starting, at the first device, the timer at a time point when the first device transmits the report.

31. The method of claim 29, further comprising:
starting, at the first device, the timer at a time point when the at least one reference resource is measured by the first device based on the antenna capability of the first device.

32. The method of claim 28, further comprising:
determining a time duration associated with the timer; and
providing, to the second device, the time duration along with a report of a set of antenna capabilities of the first device.

33. The method of claim 28, wherein determining that one or more default resources are to be used for the SRS transmission comprises:
determining a subset of resources from the one or more current usable resources as the one or more default resources, the subset of resources being corresponding to a lowest antenna capability of the first device.

34. The method of claim 28, wherein determining the transmit beam comprises,
in response to determining that the one or more default resource are configured based on an indicated Transmission Coordination Indicator (TCI) state,
determining the transmit beam based on the indicated TCI state.

35. A computer readable medium comprising program instructions tangibly stored thereon, which when executed by at least one processor, cause a first device to perform at least the following:
in response to determining that a timer associated with a validity of an antenna capability of the first device and one or more usable resources selected by the first device based on the antenna capability has expired, determine that one or more default resources are to be used for a sounding reference signal (SRS) transmission from the first device to a second device; and
determine a transmit beam associated with the SRS transmission based on the one or more default resources.
